(19) United States
(12) Patent Application Publication
(10) Pub. No.: US 2024/0028907 A1
(43) Pub. Date: Jan. 25, 2024

(54) TRAINING DATA GENERATORS AND METHODS FOR MACHINE LEARNING

(71) Applicant: Intel Corporation, Santa Clara, CA (US)

(72) Inventors: Xuesong Shi, Beijing (CN); Zhigang Wang, Beijing (CN)

(21) Appl. No.: 16/649,523

(22) PCT Filed: Dec. 28, 2017
(86) PCT No.: PCT/CN2017/119453

§ 371 Date: Mar. 20, 2020

(51) Int. Cl. G06N 3/094; G06N 3/0475

(52) U.S. Cl. CPC G06N 3/094; G06N 3/0475

(57) ABSTRACT

Training data generators and methods for machine learning are disclosed. An example method to generate training data for machine learning by generating simulated training data for a target neural network, transforming, with a training data transformer, the simulated training data form transformed training data, the training data transformer trained to increase a conformance of the transformed training data and the simulated training data, and training the target neural network with the transformed training data.

### FIELD OF THE DISCLOSURE

This disclosure relates generally to machine learning, and, more particularly, to training data generators and methods for machine learning.

### BACKGROUND

In recent years, machine learning (e.g., using neural networks) has become increasing used to train, among other things, autonomous devices (e.g., robots, self-driving cars, drones, etc.) to understand the environment(s) in which they operate and to take appropriate action.

### BRIEF DESCRIPTION OF THE DRAWINGS

FIG. 1 illustrates an example training data transformer constructed in accordance with teachings of this disclosure, and shown in an example environment of use.

FIG. 2 is a block diagram illustrating an example constrained generative adversarial network, constructed in accordance with teachings of this disclosure, for training the example training data transformer of FIG. 1.

FIG. 3 is a flowchart representative of example machine-readable instructions that may be executed to implement the example training data transformer of FIG. 1, and the example constrained generative adversarial network of FIG. 2.

FIG. 4 illustrates an example processor platform structured to execute the example machine-readable instructions of FIG. 3 to implement the example training data transformer of FIG. 1, and the example constrained generative adversarial network of FIG. 2.

Wherever beneficial, the same reference numbers will be used throughout the drawing(s) and accompanying written description to refer to the same or like parts. Connecting lines or connectors shown in the various figures presented are intended to represent example functional relationships, and/or physical or logical couplings between the various elements.

### DETAILED DESCRIPTION

Increasingly, devices are being implemented using machine learning (e.g., using neural networks). The training of such devices often requires substantial amounts of training data. However, collecting training data in the real world can be complex and expensive, especially in robot-related contexts. Synthesis (e.g., simulation, modeling, etc.) can be used to generate training data. For example, a virtual environment can be used (e.g., simulated, modeled, generated, created, maintained, etc.) to train a virtualized (e.g., simulated, modeled, etc.) version a real device (e.g., a robot). The use of virtual training has facilitated research and development on autonomous devices in virtual environments. However, virtual training has not proven as useful in training actual real-world autonomous devices to operate in the real world. One challenge is the gap between the characteristics of synthesized training data, and the characteristics of real-world training data measured in the real world. For example, real-world training data often contains some degree of inaccuracies and non-random noises, which are hard, if even possible, to model (e.g., simulate, synthesis, etc.).

Example training data generators and methods for machine learning are disclosed herein that overcome at least these difficulties. In disclosed examples, a neural network of a virtual autonomous device is trained with synthesized training data, and the neural network trained with the synthesized training data is used in a real-world autonomous device operating in the real world. Because training can take place in a virtual environment in disclosed examples, it is feasible and cost effective to generate substantial amounts of training data.

In some examples, a virtual device, a virtual component, a virtual environment, etc. refers to an entity that is non-physical, non-tangible, transitory, etc. That is, a virtual device, a virtual component, a virtual environment, etc. does not exist as an actual entity that a person can physically, tangibly, non-transitorily, etc. interact with, manipulate, handle, etc. Even when a virtual device, a virtual component, a virtual environment, etc. is instantiated or implemented by instructions executed by one or more processors, which are real-world devices, and data managed thereby, any underlying virtual device, virtual component, virtual environment, etc. is virtual in that a person cannot physically, tangibly, non-transitorily, etc. interact with, manipulate, handle, etc. the virtual device, the virtual component, the virtual environment, etc. Even when the virtual device, the virtual component, the virtual environment, etc. has a corresponding physical implementation, the virtual device, the virtual component, the virtual environment, etc. are still virtual.

Reference will now be made in detail to non-limiting examples, some of which are illustrated in the accompanying drawings.

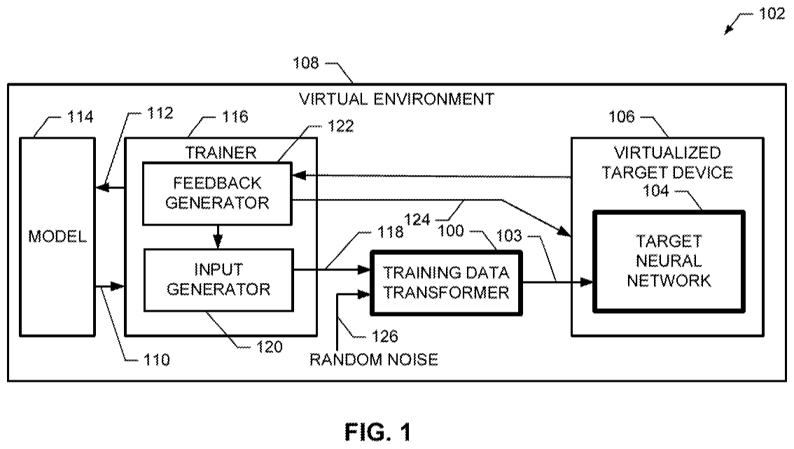

FIG. 1 illustrates an example training data transformer 100 constructed in accordance with teachings of this disclosure, and shown in an example environment of use 102. In the illustrated example environment of use 102 of FIG. 1, the example training data transformer 100 is used to form transformed training data 103 for training a target neural network 104.

In the illustrated example of FIG. 1, the target neural network 104 is implemented as part of a machine-learned virtualized target device 106 (e.g., a virtual robot, a virtual self-driving car, a virtual drone, etc.). The virtualized target device 106 is a virtual version (e.g., a simulated version, a modeled version, etc.) of a corresponding machine-learned real-world device (e.g., an actual robot, an actual self-driving car, an actual drone, etc.). In operation, the virtualized target device 106 and the target neural network 104 are intended to operate substantially as the real device and neural network to which they correspond.

To execute (e.g., operate, carry out, etc.) the example virtualized target device 106, the example environment of use 102 of FIG. 1 includes an example virtual environment 108. The example virtualized target device 106 is instantiated, and operated in the example virtual environment 108 as if the virtualized target device 106 were a real device (e.g., a non-virtual device, a non-simulated device, a non-modeled device, etc.) operating in the real world.

To create simulated inputs 110, and determine responses to outputs 112, the example virtual environment 108 of FIG. 1 includes an example model 114. An example model 114 for the virtual environment 108 for a robotic device is a physics model (e.g., the Bullet physics library).

To train the example target neural network 104, the example virtual environment 108 of FIG. 1 includes an example trainer 116. To create simulated training inputs 118, the example trainer 116 includes an example input generator 120. The example input generator 120 of FIG. 1 translate the inputs 110 formed by model 114 into simulated training data 118 that represent sensory inputs of an appendage of the virtualized target device 106 at M miles-per-hour (mph), the input generator 120 translates that generic description of an event in terms of physics (e.g., a force of N Newtons against the hand of the robot) into, for example, simulated training data 118 representing a voltage of v volts (V) on the sensor in the middle of the appendage.

To generate feedback for the virtualized target device 106, the example trainer 116 includes an example feedback generator 122. The example feedback generator 122 of FIG. 1 determines what in the virtual environment 108 is impacted by an action of the virtualized target device 106 or another device in the virtual environment 102. In response, the example feedback generator 122 determines what inputs 118 need to be provided by the input generator 120 to the virtualized target device 106. As is common in machine-learned systems such as the virtualized target device 106, in some examples, the feedback generator 122 provides feedback 124 in the form of error values, loss values, reinforcement feedback, etc.

The transformed training data 103 may be associated with any number and/or type(s) of type of sensors and/or input devices of the virtualized target device 106. The imperfections (e.g., noises, non-linearities, etc.) of real sensors and/or input devices usually have complex characteristics that are very difficult to model in a linear and/or statistical way. For example, depth cameras (e.g. an Intel RealSense camera), which are widely used on robots have relatively strong and complicated noises. For example, depth images tend to have large noises at the edge of objects. Such kind of noises cannot be generated by additive random noise. Thus, in general, it is difficult, often impractical, to simulate real-world (e.g., actual) sensory and/or input device signals realistically by programming. Without sufficient realness and conformity to simulated training data, the training data 103 is likely to fail to train the target neural network 104 to work as intended in the real world.

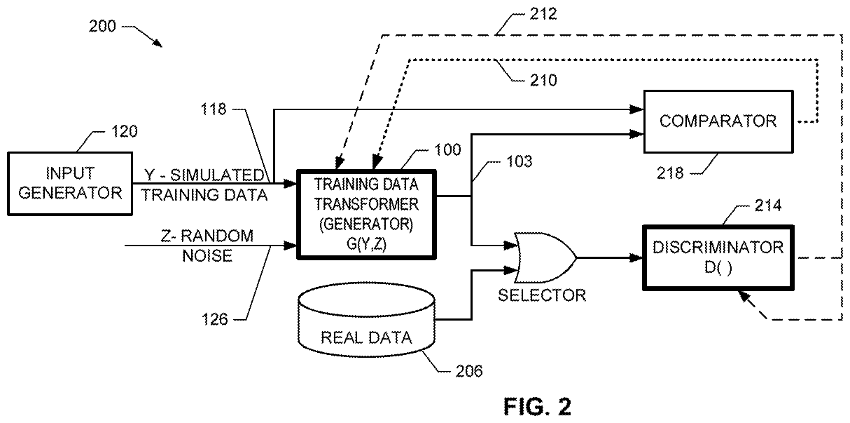

Thus, as will be explained below in connection with FIG. 2, a constrained generative adversarial network is used to train the example machine-learned training data transformer 100 to transform the simulated training data 118 into transformed training data 103 that is more representative of real-world sensors and/or input devices, and simulated training data. The example training data transformer 100 in FIG. 1 uses random noise inputs 126 to provide the uncertainty of noises in the training data 103. Having transformed the simulated training data 118 into the transformed training data 103, the transformed training data 103 includes the characteristics (e.g., noises, non-linearities, etc.) representative of real-world sensory and/or input device signals. Accordingly, the target neural network 104 can be used, as trained in the virtual environment 108, in a real-world environment.

In this way, the example training data transformer 100, the example virtual environment 108, the example model 114, the example trainer 116, the example input generator 120 and the example feedback generator 122 cooperate to provide a responsive environment in which the virtualized target device 106 receives inputs and provides outputs as if the virtualized target device 106 were operating in a real-world environment.

While an example manner of implementing the example environment of use 102 is illustrated in FIG. 1, one or more of the elements, processes and/or devices illustrated in FIG. 1 may be combined, divided, re-arranged, omitted, eliminated and/or implemented in any other way. Further, the example training data transformer 100, the example virtual environment 108, the example model 114, the example trainer 116, the example input generator 120 and the example feedback generator 122 and/or, more generally, the example environment of use 102 of FIG. 1 may be implemented by hardware, software, firmware and/or any combination of hardware, software and/or firmware. Thus, for example, any of the example the example training data transformer 100, the example virtual environment 108, the example model 114, the example trainer 116, the example input generator 120 and the example feedback generator 122 and/or, more generally, the example environment of use 102 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate array(s) (FPGA(s)), and/or field programmable logic device(s) (FPLD(s)). When reading any of the apparatus or system claims of this patent to cover a purely software and/or firmware implementation, at least one of the example training data transformer 100, the example virtual environment 108, the example model 114, the example trainer 116, the example input generator 120 and the example feedback generator 122, and/or the example environment of use 102 is/are hereby expressly defined to include a non-transitory computer readable storage device or storage disk such as a memory, a digital versatile disk (DVD), a compact disk (CD), a Blu-ray disk, etc. including the software and/or firmware. Further still, the example environment of use 102 of FIG. 1 may include one or more elements, processes and/or devices in addition to, or instead of, those illustrated in FIG. 1, and/or may include more than one of any or all the illustrated elements, processes and devices.

FIG. 2 is a block diagram illustrating an example constrained generative adversarial network (GAN) 200, constructed in accordance with teachings of this disclosure, for training the example training data transformer 100 of FIG. 1. GANs have been used to jointly train a generator and a discriminator. GANs were first described by Goodfellow et al. in a paper entitled “Generative Adversarial Networks,” and published in Advances in Neural Information Processing Systems, 2014, pp. 2672-2680, which is hereby incorporated by reference in its entirety. The conventional GANs described by Goodfellow et al., and their variants, have been studied in the context of photorealistic image generation, natural language generation, and several other domains. In conventional GANs, the generator uses a vector of random noise as its inputs because the generator cannot itself provide the randomness necessary to ensure the diversity of the output of the generator. While conventional GANs work in other domains, conventional GANs cannot properly generate training data that mimics the real-world sensory and/or input device signals of real-world autonomous devices (e.g., robots, self-driving cars, drones, etc.) because only random noise inputs are used in conventional GANs. To generate training data that mimics real-world sensory and/or input device signals it is necessary that generated training data both (a) conform to (e.g., be close to, be like, be like, etc.) simulated training data generated by, for example, the input generator 120 of FIG. 1, and (b) be like real-world sensory and/or input device signals. The constraint that that generated training data conform to simulated training data generated by, for example, the input generator 120 of FIG. 1 is not contemplated in conventional GANs.

The example constrained GAN 200 of FIG. 2 represents an example GAN that incorporates the additional constraint that a training data transformer (generator) neural network 100 generate the training data 103 that conform to simulated training data generated by, for example, the input generator 120 of FIG. 1. The example GAN 200 is referred to herein as a constrained GAN because of the additional constraint on the conformity of the generated training data 103 to the simulated training data 118. As illustrated, in some examples, the example training data transformer (generator) 100 of FIG. 1 is trained using the example constrained GAN 200. The trained training data transformer (generator) 100 is used, as trained, in the illustrated example of FIG. 1. While the example of FIG. 2 shows training the training data transformer 100, the example constrained GAN 200 can be used to train a generator neural network for other applications.

The example real-world sensory and/or input device signals 206 of FIG. 2 are measured using any number and/or type(s) of real-world sensory and/or inputs devices in real-world environments and, thus, can be referred to as real data 206. In some examples, the real data 206 is measured to ensure representative real-world sensory and/or input device signals are captured and included. The real data 206 may be stored using any number and/or type(s) of data structures on any number and/or type(s) of data stores.

To generate the simulated training data 103, the example constrained GAN 200 includes the example training data transformer (generator) 100. The example training data transformer (generator) 100 is trained (e.g., its taps, connection weights, coefficients, etc. adjusted, adapted, etc.) using the simulated training data 118 (y) and the random noise 126 (z) as inputs, and a combination of a distortion loss 210 and a realness loss 212 as a combined loss feedback. An example combined loss feedback can be expressed mathematically as

L_{G}(y,z)=−ƒᵣₑₐₗₙₑₛₛ(D(G(y,z)))+αƒ_{distortion}(G y,z),y), EQN (1)

where G(y,z) is the transform learned by the training data transformer (generator) 100, θ_{distortion}G((y,z),y) is a measure of the distortion loss 210 between the simulated training data 118 and the training data 103 output by the training data transformer (generator) 100, D( ) is the transform learned by a discriminator neural network 214, which depends on the training data 103 output by the training data transformer (generator) 100, ƒᵣₑₐₗₙₑₛₛ(D(G(y,z))) is a measure of the realness loss 212 determined by the discriminator neural network 214, and a is a scale factor that can be used to adjust the relative contributions of the distortion loss 210 and the realness loss 212. The distortion loss 210 represents the additional constraint that the training data 103 conform to (e.g., be close to, be like, be like, etc.) the simulated training data 118. This distortion loss 210 is not contemplated in conventional GANs.

To compute the distortion loss 210, the example constrained GAN 200 of FIG. 2 includes an example comparator 218. The example comparator 218 of FIG. 2 computes the distortion loss 210 using any number and/or type(s) of method(s), algorithm(s), calculation(s), operation(s), etc. Example methods of computing the distortion loss 210 can be expressed mathematically as

$${f}_{distortion} ( x , y ) = {‖ x - y ‖}_{2}^{2} . \qquad EQN ( 2 )$$

$${f}_{distortion} ( x , y ) = {‖ x - y ‖}_{1} . \qquad EQN ( 3 )$$

$${f}_{distortion} ( x , y ) = {\sum }_{i} p σ ( a - {x}_{i} ) + q σ ( {x}_{i} - b ) , \qquad EQN ( 4 )$$

$$where σ ( x ) = \{ \begin{matrix}x , x > 0 \\ 0 , x \leq 0\end{matrix} .$$

The examples of EQN (2) and EQN (3) use differences between x and y to drive x to be close toy element-wisely. The example of EQN (4) drives elements of vector x to be within [a, b] (e.g., differences between x and a and/or b, and does not depend on y. In some examples, the distortion loss values 210 of EQN (2), EQN (3) and/or EQN (4) are combined.

To discriminate between the generated training data 103 and the real data 206, the example constrained GAN 200 includes the example discriminator 214. The example discriminator 214 of FIG. 2 is trained (e.g., its taps, connection weights, coefficients, etc. adjusted, adapted, etc.) alternatively in a periodic or aperiodic arrangement with the generated training data 103 and the real data 206 as inputs, and the realness loss 212 as a feedback. The example discriminator 214 also computes the realness loss 212. In some examples, the realness loss 212 is computed using a loss function used in conventional GANs. Other example realness loss functions are described by Arjovsky et al. in a paper entitled “Wasserstein GAN,” Jan. 26, 2017, available for download at https://arxiv.org/abs/1701.07875, and which is incorporated herein by reference in its entirety. Other realness loss functions may be used.

The example training data transformer (generator) 100 and the example discriminator 214 may be implemented using neural networks, designed according to the format of input(s) and/or output(s) of the networks. In some examples, the sensory data is a vector, the vector y and the vector z are concatenated, and the training data transformer (generator) 100 and discriminator 214 are fully connected neural networks. In some examples, the sensory data is an image or other 2-D data, the training data transformer (generator) 100 is a fully convolutional network, a deep encoder-decoder (e.g., SegNet), a deep convolutional network (e.g., DeepLab) with both input and output as an image, and the random noise z sent to the input layer or a hidden layer either by concatenated to the output the preceding layer or by introducing an additional channel. The discriminator 214 could be a convolutional neural network.

While an example constrained GAN 200 is illustrated in FIG. 2, one or more of the elements, processes and/or devices illustrated in FIG. 2 may be combined, divided, re-arranged, omitted, eliminated and/or implemented in any other way. Further, the example training data transformer (generator) 100, the example discriminator 214, the example comparator 218, and/or, more generally, the constrained GAN 200 of FIG. 2 may be implemented by hardware, software, firmware and/or any combination of hardware, software and/or firmware. Thus, for example, any of the example training data transformer (generator) 100, the example discriminator 214, the example comparator 218, and/or, more generally, the constrained GAN 200 could be implemented by one or more analog or digital circuit(s), logic circuits, programmable processor(s), programmable controller(s), GPU(s), DSP(s), ASIC(s), PLD(s), FPGA(s), and/or FPLD(s). When reading any of the apparatus or system claims of this patent to cover a purely software and/or firmware implementation, at least one of the example training data transformer (generator) 100, the example discriminator 214, the example comparator 218, and/or the constrained GAN 200 is/are hereby expressly defined to include a non-transitory computer readable storage device or storage disk such as a memory, a DVD, a CD, a Blu-ray disk, etc. including the software and/or firmware. Further still, the example constrained GAN 200 may include one or more elements, processes and/or devices in addition to, or instead of, those illustrated in FIG. 2, and/or may include more than one of any or all the illustrated elements, processes and devices.

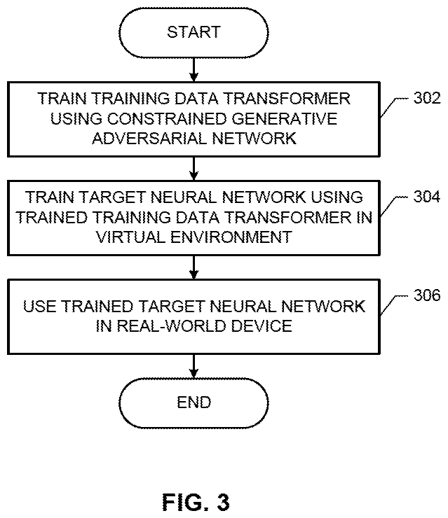

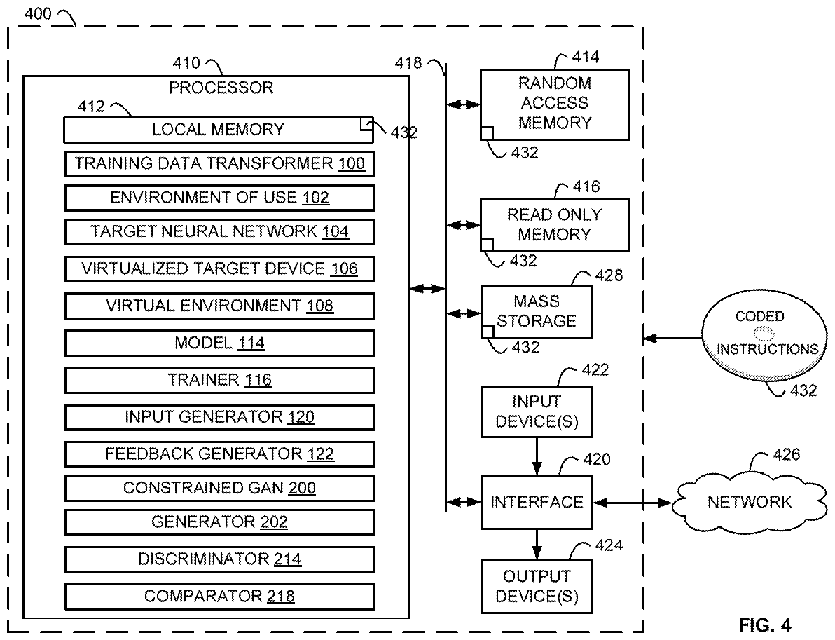

A flowchart representative of example machine-readable instructions for training, in a virtual environment, a training neural network for use in a real-world device is shown in FIG. 3. In this example, the machine-readable instructions comprise a program for execution by a processor such as the processor 410 shown in the example processor platform 400 discussed below in connection with FIG. 4. The program may be embodied in software stored on a non-transitory computer readable storage medium such as a CD, a floppy disk, a hard drive, a DVD, a Blu-ray disk, or a memory associated with the processor 410, but the entire program and/or parts thereof could alternatively be executed by a device other than the processor 410 and/or embodied in firmware or dedicated hardware. Further, although the example program is described with reference to the flowchart illustrated in FIG. 4, many other methods of training, in a virtual environment, a training neural network for use in a real-world device may alternatively be used. For example, the order of execution of the blocks may be changed, and/or some of the blocks described may be changed, eliminated, or combined. Additionally, and/or alternatively, any or all the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIG. 3 may be implemented using coded instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

The program of FIG. 3 begins at block 302 with training the training data transformer 100 of FIG. 1 using the constrained GAN 200 of FIG. 2 (block 302). For example, the simulated training data 118 is passed into the constrained GAN 200 while coefficients (e.g., taps, connections, weights, etc.) of the training data transformer (generator) 100 and the discriminator 214 are trained (e.g., updated, adapted, etc.) to the reduce the distortion loss 210 and the realness loss 212.

Once trained using the constrained GAN 200 of FIG. 2, the training data transformer (generator) 100 of FIG. 2 is used, as shown in the example of FIG. 1 to transform simulated training data 118 into training data 103, which is used in the virtual environment 108 to train the target neural network 104 (block 304). For example, the training data 103 is used to train (e.g., updated, adapted, etc.) coefficients (e.g., taps, connections, weights, etc.) of the target neural network 104.

The target neural network 104 trained in the virtual environment 108 is used in a real-world device (e.g., a robot, a self-driving car, a drone, etc.) (block 306). Control exits from the example program of FIG. 3.

FIG. 4 is a block diagram of an example processor platform 400 capable of executing the instructions of FIG. 3 to implement the example training data transformer 100 and the example environment of use 102 of FIG. 1, and the example constrained GAN 200 of FIG. 2. The processor platform 400 can be, for example, a server, a personal computer, a workstation, a laptop computer, a self-learning machine (e.g., a neural network), or any other type of computing device.

The processor platform 400 of the illustrated example includes a processor 410. The processor 410 of the illustrated example is hardware. For example, the processor 410 can be implemented by one or more integrated circuits, logic circuits, microprocessors, GPUs, DSPs or controllers from any desired family or manufacturer. The hardware processor may be a semiconductor based (e.g., silicon based) device. In this example, the processor implements the example training data transformer 100, the example environment of use 102, the example target neural network 104, the example virtualized target device 106, the example virtual environment 108, the example model 114, the example trainer 116, the example input generator 120, the example feedback generator 122, the example constrained GAN 200, the example training data transformer (generator) 100, the example discriminator 214, and the example comparator 218.

The processor 410 of the illustrated example includes a local memory 412 (e.g., a cache). The processor 410 of the illustrated example is in communication with a main memory including a volatile memory 414 and a non-volatile memory 416 via a bus 418. The volatile memory 414 may be implemented by Synchronous Dynamic Random-access Memory (SDRAM), Dynamic Random-access Memory (DRAM), RAMBUS® Dynamic Random-access Memory (RDRAM®) and/or any other type of random-access memory device. The non-volatile memory 416 may be implemented by flash memory and/or any other desired type of memory device. Access to the main memory 414, 416 is controlled by a memory controller (not shown).

The processor platform 400 of the illustrated example also includes an interface circuit 420. The interface circuit 420 may be implemented by any type of interface standard, such as an Ethernet interface, a universal serial bus (USB) interface, a BLUETOOTH® interface, a near field communication (NFC) interface, and/or a peripheral component interface (PCI) express interface.

In the illustrated example, one or more input devices 422 are connected to the interface circuit 420. The input device(s) 422 permit(s) a user to enter data and/or commands into the processor 412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 424 are also connected to the interface circuit 420 of the illustrated example. The output devices 424 can be implemented, for example, by display devices (e.g., a light emitting diode (LED), an organic light emitting diode (OLED), a liquid crystal display (LCD), a cathode ray tube display (CRT), an in-plane switching (IPS) display, a touchscreen, etc.) a tactile output device, a printer, and/or speakers. The interface circuit 420 of the illustrated example, thus, typically includes a graphics driver card, a graphics driver chip and/or a graphics driver processor.

The interface circuit 420 of the illustrated example also includes a communication device such as a transmitter, a receiver, a transceiver, a modem, a residential gateway, and/or network interface to facilitate exchange of data with external machines (e.g., computing devices of any kind) via a network 426 (e.g., an Ethernet connection, a digital subscriber line (DSL), a telephone line, a coaxial cable, a cellular telephone system, a Wi-Fi system, etc.).

The processor platform 400 of the illustrated example also includes one or more mass storage devices 428 for storing software and/or data. In the illustrated example, the mass storage devices 428 store the example real data 206 of FIG. 2. Examples of such mass storage devices 428 include floppy disk drives, hard drive disks, CD drives, Blu-ray disk drives, redundant array of independent disks (RAID) systems, and DVD drives.

Coded instructions 432 including the coded instructions of FIG. 3 may be stored in the mass storage device 428, in the volatile memory 414, in the non-volatile memory 416, and/or on a removable tangible computer readable storage medium such as a CD or DVD.

Example training data generators and methods for machine learning are disclosed herein. Further examples and combinations thereof include at least the following.
Example 1 includes a method to generate training data for machine learning, the method including:
generating simulated training data for a target neural network;
transforming, with a training data transformer, the simulated training data form transformed training data, the training data transformer trained to increase a conformance of the transformed training data and the simulated training data; and
training the target neural network with the transformed training data.
Example 2 is the method of example 1, further including receiving outputs of the target neural network during the training, the training of the training data transformer based on feedback for the outputs.
Example 3 is the method of example 1, further including:
generating the simulated training data within a virtual environment; and training the target neural network with the transformed training data in a virtual device in the virtual environment, the virtual device including the target neural network.
Example 4 is the method of example 3, the training the target neural network forming a trained target neural network, and further including:
operating the trained target neural network in a real-world device; and
operating the real-world device in a real-world environment in response to actual inputs in the real-world environment.
Example 5 is the method of example 1, wherein the real-world device includes a machine-learned autonomous device.
Example 6 is the method of example 1, wherein the real-world device includes at least one of a robot, a self-driving car, or a drone.
Example 7 is the method of example 1, wherein the target neural network includes a first neural network, and the training data transformer includes a second neural network.
Example 8 includes a generative adversarial network, including:
an input generator to generate simulated training data for a target neural network, the simulated training data generated in a virtual environment; and
a generator neural network to
   generate training data from the simulated training data, and
   update one or more coefficients of the generator neural network based on a first difference between the training data and the simulated training data, and a second difference between the training data and actual input data, the actual input data measured in a real-world environment.
Example 9 is the generative adversarial network of example 8, further including:
a discriminator neural network to determine the second difference, and compute a first loss value based on the second difference,
the generator neural network to update the one or more coefficients updated based on the first loss value.
Example 10 is the generative adversarial network of example 9, further including:
a comparator to determine the first difference between the training data and the simulated training data, and compute a second loss value based on the first difference; and
the generator neural network to update the one or more coefficients updated based on the first loss value and the second loss value.
Example 11 is the generative adversarial network of example 8, further including:
a discriminator neural network to determine the second difference, compute a first loss value based on the second difference, and update based on the first loss value; and
a comparator to determine the first difference between the training data and the simulated training data, and compute a second loss value based on the first difference;
the generator neural network to update the one or more coefficients updated based on the first loss value and the second loss value.
Example 12 is the generative adversarial network of example 8, further including:
a processor; and
a non-transitory computer-readable storage medium storing instructions that, when executed by the processor, cause the processor to:
   execute the input generator and the generator in the virtual environment to train the target neural network in the virtual environment to form a trained target neural network, the trained target neural network executable in a real environment without the generator.
Example 13 includes a non-transitory computer-readable storage medium storing instructions that, when executed, cause a machine to:
training a generator neural network of a generative adversarial network based on a first difference between output data of the generator neural network and input data of the generator neural network, and a second difference between the output data and actual data, the actual data measured in a real-world environment;
training, in a virtual environment, a target neural network using the generator neural network to transform simulated training data into training data for the target neural network; and
operating the target neural network in a real-world device.
Example 14 is the non-transitory computer-readable storage medium of example 13, wherein the instructions, when executed, the machine to train the generator neural network by:
determining a first difference between the output data and the input data;
computing a distortion loss value based on the first difference;
determining a second difference between the output data and the real-world data;
computing a realness loss value based on the second difference; and
training the generator neural network based on the distortion loss value and the realness loss value.
Example 15 is the non-transitory computer-readable storage medium of example 13, wherein the instructions, when executed, the machine to generate the simulated training data using a model of a real-world environment.
Example 16 is the non-transitory computer-readable storage medium of example 13, wherein the instructions, when executed, the machine to train the target neural network using a virtualization of the real-world device.
Example 17 includes a method to generate training data for machine learning, the method including:
generating simulated training data for a target neural network;
transforming, with a training data transformer, the simulated training data form transformed training data, the training data transformer trained to increase a conformance of the transformed training data and the simulated training data; and
training the target neural network with the transformed training data.
Example 18 is the method of example 17, further including receiving outputs of the target neural network during the training, the training of the training data transformer based on feedback for the outputs.
Example 19 is the method of example 17 or example 18, further including:
generating the simulated training data within a virtual environment; and
training the target neural network with the transformed training data in a virtual device in the virtual environment, the virtual device including the target neural network.
Example 20 is the method of example 19, the training the target neural network forming a trained target neural network, and further including:
operating the trained target neural network in a real-world device; and
operating the real-world device in a real-world environment in response to actual inputs in the real-world environment.
Example 21 is the method of example claim 20, wherein the real-world device includes a machine-learned autonomous device.
Example 22 is the method of example 20, wherein the real-world device includes at least one of a robot, a self-driving car, or a drone.
Example 23 includes the method of any of examples 17 to 22, wherein the target neural network includes a first neural network, and the training data transformer includes a second neural network.
Example 24 includes a non-transitory computer-readable storage medium storing instructions that, when executed, cause a computer processor to perform the method of any of example 17 to example 23.
Example 25 includes generative adversarial network, including:
an input generator to generate simulated training data for a target neural network, the simulated training data generated in a virtual environment; and
a generator neural network to
   generate training data from the simulated training data, and
   update one or more coefficients of the generator neural network based on a first difference between the training data and the simulated training data, and a second difference between the training data and actual input data, the actual input data measured in a real-world environment.
Example 26 is the generative adversarial network of example 25, further including:
a discriminator neural network to determine the second difference, and compute a first loss value based on the second difference,
the generator neural network to update the one or more coefficients updated based on the first loss value.
Example 27 is the generative adversarial network of example 25, further including:
a comparator to determine the first difference between the training data and the simulated training data, and compute a second loss value based on the first difference; and
the generator neural network to update the one or more coefficients updated based on the first loss value and the second loss value.
Example 28 is the generative adversarial network of example 25, further including:
a discriminator neural network to determine the second difference, compute a first loss value based on the second difference, and update based on the first loss value; and
a comparator to determine the first difference between the training data and the simulated training data, and compute a second loss value based on the first difference;
the generator neural network to update the one or more coefficients updated based on the first loss value and the second loss value.
Example 29 is the generative adversarial network of examples 25 to 28, further including:
a processor; and
a non-transitory computer-readable storage medium storing instructions that, when executed by the processor, cause the processor to:
   execute the input generator and the generator in the virtual environment to train the target neural network in the virtual environment to form a trained target neural network, the trained target neural network executable in a real environment without the generator.
Example 30 includes a non-transitory computer-readable storage medium storing instructions that, when executed, cause a machine to:
training a generator neural network of a generative adversarial network based on a first difference between output data of the generator neural network and input data of the generator neural network, and a second difference between the output data and actual data, the actual data measured in a real-world environment;
training, in a virtual environment, a target neural network using the generator neural network to transform simulated training data into training data for the target neural network; and
operating the target neural network in a real-world device.
Example 31 is the non-transitory computer-readable storage medium of example 30, wherein the instructions, when executed, the machine to train the generator neural network by:
determining a first difference between the output data and the input data;
computing a distortion loss value based on the first difference;
determining a second difference between the output data and the real-world data;
computing a realness loss value based on the second difference; and
training the generator neural network based on the distortion loss value and the realness loss value.
Example 32 is the non-transitory computer-readable storage medium of example 30 or example 31, wherein the instructions, when executed, the machine to generate the simulated training data using a model of a real-world environment.
Example 33 is the non-transitory computer-readable storage medium of examples 30 to 32, wherein the instructions, when executed, the machine to train the target neural network using a virtualization of the real-world device.
Example 34 includes a system, including:
a means for generating simulated training data for a target neural network, the simulated training data generated in a virtual environment; and
a means for
   generating training data from the simulated training data, and
   updating one or more coefficients of the generator neural network based on a first difference between the training data and the simulated training data, and a second difference between the training data and actual input data, the actual input data measured in a real-world environment.
Example 35 is the system of example 34, further including:
a means for determining the second difference, and compute a first loss value based on the second difference,
the means for updating to update the one or more coefficients based on the first loss value.
Example 36 is the system of example 34, further including:
a means for determining the first difference between the training data and the simulated training data, and compute a second loss value based on the first difference; and
the means for updating to update the one or more coefficients based on the first loss value and the second loss value.
Example 37 is the system of example 34, further including:
a means for determining the second difference, compute a first loss value based on the second difference, and update based on the first loss value; and
a means for determining the first difference between the training data and the simulated training data, and compute a second loss value based on the first difference;
the means for updating to update the one or more coefficients based on the first loss value and the second loss value.

“Including” and “comprising” (and all forms and tenses thereof) are used herein to be open ended terms. Thus, whenever a claim lists anything following any form of “include” or “comprise” (e.g., comprises, includes, comprising, including, having, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1-17. (canceled)

18. A method to generate training data for machine learning, the method comprising:
generating simulated training data for a target neural network;
transforming, with a training data transformer, the simulated training data form transformed training data, the training data transformer trained to increase a conformance of the transformed training data and the simulated training data; and
training the target neural network with the transformed training data.

19. The method of claim 18, further including receiving outputs of the target neural network during the training, the training of the training data transformer based on feedback for the outputs.

20. The method of claim 18, further including:
generating the simulated training data within a virtual environment; and
training the target neural network with the transformed training data in a virtual device in the virtual environment, the virtual device including the target neural network.

21. The method of claim 20, the training the target neural network forming a trained target neural network, and further including:
operating the trained target neural network in a real-world device; and
operating the real-world device in a real-world environment in response to actual inputs in the real-world environment.

22. The method of claim 18, wherein the real-world device includes a machine-learned autonomous device.

23. The method of claim 18, wherein the real-world device includes at least one of a robot, a self-driving car, or a drone.

24. The method of claim 18, wherein the target neural network includes a first neural network, and the training data transformer includes a second neural network.

25. A generative adversarial network, comprising:
an input generator to generate simulated training data for a target neural network, the simulated training data generated in a virtual environment; and
a generator neural network to
generate training data from the simulated training data, and
update one or more coefficients of the generator neural network based on a first difference between the training data and the simulated training data, and a second difference between the training data and actual input data, the actual input data measured in a real-world environment.

26. The generative adversarial network of claim 25, further including:
a discriminator neural network to determine the second difference, and compute a first loss value based on the second difference,
the generator neural network to update the one or more coefficients updated based on the first loss value.

27. The generative adversarial network of claim 26, further including:
a comparator to determine the first difference between the training data and the simulated training data, and compute a second loss value based on the first difference; and
the generator neural network to update the one or more coefficients updated based on the first loss value and the second loss value.

28. The generative adversarial network of claim 25, further including:
a discriminator neural network to determine the second difference, compute a first loss value based on the second difference, and update based on the first loss value; and
a comparator to determine the first difference between the training data and the simulated training data, and compute a second loss value based on the first difference;
the generator neural network to update the one or more coefficients updated based on the first loss value and the second loss value.

29. The generative adversarial network of claim 25, further including:
a processor; and
a non-transitory computer-readable storage medium storing instructions that, when executed by the processor, cause the processor to:
execute the input generator and the generator in the virtual environment to train the target neural network in the virtual environment to form a trained target neural network, the trained target neural network executable in a real environment without the generator.

30. A non-transitory computer-readable storage medium comprising instructions that, when executed, cause a machine to:
train a generator neural network of a generative adversarial network based on a first difference between output data of the generator neural network and input data of the generator neural network, and a second difference between the output data and actual data, the actual data measured in a real-world environment;
train, in a virtual environment, a target neural network using the generator neural network to transform simulated training data into training data for the target neural network; and
operate the target neural network in a real-world device.

31. The non-transitory computer-readable storage medium of claim 30, wherein the instructions, when executed, the machine to, in order to train the generator neural network:
determine a first difference between the output data and the input data;
compute a distortion loss value based on the first difference;
determine a second difference between the output data and the real-world data;
compute a realness loss value based on the second difference; and
train the generator neural network based on the distortion loss value and the realness loss value.

32. The non-transitory computer-readable storage medium of claim 30, wherein the instructions, when executed, the machine to generate the simulated training data using a model of a real-world environment.

33. The non-transitory computer-readable storage medium of claim 30, wherein the instructions, when executed, the machine to train the target neural network using a virtualization of the real-world device.
